(19) United States
(12) Patent Application Publication
(10) Pub. No.: US 2017/0297962 A1
(43) Pub. Date: Oct. 19, 2017

(54) ORGANIC FERTILIZER FROM ANAEROBIC DIGESTATE AND STABILIZED LIQUID FISH PRODUCT

(71) Applicant: True Organic Products, Inc., Helm, CA (US)

(72) Inventor: Jacob Matthew Evans, Pebble Beach, CA (US)

(73) Assignee: True Organic Products, Inc., Helm, CA (US)

(21) Appl. No.: 15/098,040

(22) Filed: Apr. 13, 2016

(51) Int. Cl. C05C 11/00; C05B 17/00; A01C 21/00

(52) U.S. Cl. CPC C05C 11/00; A01C 21/00; C05B 17/00

(57) ABSTRACT

A process for production of anaerobic digestate based organic fertilizer includes combining anaerobic digestate and one or more stabilized liquid fish products to create a combination of anaerobic digestate and one or more stabilized liquid fish products. The combination of anaerobic digestate and one or more stabilized liquid fish products is processed to yield the anaerobic digestate based organic fertilizer product.

### BACKGROUND

As the world's population continues its rapid growth, there is a rising issue of waste disposal. Food waste is no exception. For example, in the United States, it is estimated that food loss accounts for 133 billion pounds of waste per year and, unsurprisingly, has an incredible impact on the environment. This waste accounts for over twenty percent of total U.S. municipal solid waste discards after recycling and composting. Shockingly, wasted food accounts for the single largest component of disposed municipal solid waste.

Furthermore, food waste is a leading contributor to landfill methane emissions, which themselves constitute approximately 18 percent of total methane emissions in the United States. Indeed, landfills are the third largest methane source in the United States.

Because of the significant issues presented by disposing of food waste, the government has begun implementing programs to mitigate the effects of wasted food. At a state level, attempts are being made to address food waste disposal issues. For example, in California, where 5.6 million tons of annual food waste make up 18.1% of the state's overall waste stream, the California government passed a law requiring businesses to recycle “organic waste,” which is defined as “food waste, green waste, landscape and pruning waste, nonhazardous wood waste, and food-soiled paper waste that is mixed in with food waste.” CAL. PuB. RES. CODE §42649.8 (2015). Since businesses will no longer be able to divert their organic waste to landfills, they are scrambling to determine how to dispose of these materials.

One solution is anaerobic digestion. Occurring naturally in oxygen-poor environments like marshes and landfills, anaerobic digestion takes place when microorganisms break down biodegradable material in the absence of oxygen. Commercially, anaerobic digestion technologies are used to break down widely available waste materials such as livestock manure, municipal wastewater solids, food waste, industrial wastewater and residuals, fats, oils, and grease. Thus, anaerobic digesters can be used to dispose of food waste and other biodegradable materials.

The by-products of anaerobic digestion include biogas, digestate, and water. Biogas, such as methane (CH₄) and carbon dioxide (CO₂), can be combusted to generate electricity and heat or can be processed into renewable natural gas and transportation fuels.

The anaerobic digestates that result from anaerobic digestion include solid and liquid residues with alkaline pH levels. Problematically, the anaerobic digestates often contains elements that cannot be digested by the anaerobic microorganisms on which the anaerobic digestion process depends. Depending on their source, digestates can contain pathogens, which can lead to human, animal, or plant disease. Furthermore, the digestates may be contaminated with heavy metals, inorganic compounds such as ammonia, and organic compounds. Additionally, the content of macro-elements, particularly nitrogen, phosphorous and potassium must be considered. Moreover, anaerobic digestates may have an undesirable appearance and odor.

Although anaerobic digestion is sometimes touted as a panacea to food waste disposal issues, the reality is that the anaerobic digestates themselves must be distributed. There is a need for an environmentally benign product derived from anaerobic digestates that is produced in such a way as to minimize the problems associated with anaerobic digestates.

### SUMMARY

The present Inventor, recognizing the issues associated with anaerobic digestates, has developed a method of producing an organic fertilizer by combining and processing anaerobic digestates with stabilized liquid fish products.

Anaerobic digestates contain levels of available nitrogen, particularly in the form of ammonia, as well as other nutrients that are beneficial for plant growth. As discussed above, anaerobic digestates are unstable with an alkaline pH. In fact, ammonia contamination in anaerobic digestates is a long-standing and well-recognized problem. Without treatment, the anaerobic digestate undergoes continuing microbial activity, which results in a rotted and ruined product. In fact, ammonia contamination is a long-standing and well-recognized problem associated with anaerobic digestion; capturing ammonia without ruining the anaerobic digestate through rotting is incredibly difficult. Compounding this issue, under National Organic Program standards, the regulatory framework governing organic food production, stabilizers such as phosphoric acid and sulfuric acid that can prevent spoliation may not be added to anaerobic digestates that are to be used in organic fertilizer products.

The Inventor, however, recognized that under the National Organic Program, liquid fish products can be treated with citric acid, phosphoric acid, and sulfuric acid and still be used as a fertilizer for organic food. Specifically, 7 CFR 205.601 provides that liquid fish products “can be pH adjusted with sulfuric, citric or phosphoric acid. The amount of acid used shall not exceed the minimum need to lower the pH to 3.5.”

Therefore, the Inventor realized that he could combine anaerobic digestate and liquid fish products treated with sulfuric, citric, or phosphoric acid to create an organic fertilizer product that includes stabilized anaerobic digestate and meets National Organic Program standards.

In accordance with one embodiment, a process of production of an anaerobic digestate based organic fertilizer product is disclosed. In one embodiment, anaerobic digestate is obtained. In one embodiment, one or more stabilized liquid fish products are obtained.

In one embodiment, the anaerobic digestate and the one or more stabilized liquid fish products are combined to yield the anaerobic digestate based organic fertilizer product. In one embodiment, the anaerobic digestate is combined with the one or more stabilized liquid fish products such that the resulting combination of anaerobic digestate and one or more stabilized liquid fish products is 10% to 90% anaerobic digestate. In one embodiment, the anaerobic digestate is combined with the one or more stabilized liquid fish products such that the resulting combination of anaerobic digestate and one or more stabilized liquid fish products is 10% to 90% one or more stabilized liquid fish products. In other embodiments, the anaerobic digestate is combined with one or more stabilized liquid fish products such that the resulting combination of anaerobic digestate and one or more stabilized liquid fish products is any desired percentage concentration of anaerobic digestate and one or more stabilized liquid fish products.

In one embodiment, the combination of anaerobic digestate and one or more stabilized liquid fish products is filtered to remove suspended particulate matter. In one embodiment, filtration is provided using a wire mesh size in a range of 50 to 200.

In one embodiment, the combination of anaerobic digestate and one or more stabilized liquid fish products is aerated.

In one embodiment, the combination of anaerobic digestate and one or more stabilized liquid fish products is optionally heat-treated. In one embodiment, the combination of anaerobic digestate and one or more stabilized liquid fish products is optionally treated and filtered to remove suspended particulate matter.

In one embodiment, the optional heat-treatment is performed in a range of about 130 to 200 degrees Fahrenheit (F) for up to 15 days.

In one embodiment, the heat-treated combination of anaerobic digestate and one or more stabilized liquid fish products is cooled to yield the anaerobic digestate based organic fertilizer product.

In one embodiment, the heat-treated combination of anaerobic digestate and one or more stabilized liquid fish products is filtered pre- and/or post-cooling. In one embodiment, filtration is provided using a wire mesh size in a range of 50 to 200.

In one embodiment, the anaerobic digestate based organic fertilizer product is applied to fields of agricultural vegetation in quantities in the approximate range of 5 to 4000 gallons per acre. In one embodiment, the anaerobic digestate based organic fertilizer product disclosed herein is applied to the fields of agricultural vegetation either directly or by inclusion in an irrigation stream.

Using the process for production of an anaerobic digestate based organic fertilizer product disclosed herein, an anaerobic digestate based organic fertilizer product is provided that is environmentally benign; is non-pathogenic; is derived from a natural organic source; does not require significant processing; has minimal odor; has a low viscosity liquid form; can be applied directly to agricultural vegetation; can be injected and/or added into irrigation streams; includes time-released nitrogen components which become bioavailable to agricultural vegetation by beneficial microbial digestion in soil; and eliminates chemical crop burning.

As discussed in more detail below, using the below embodiments, with little or no modification and/or user input, there is considerable flexibility, adaptability, and opportunity for customization to meet the specific needs of various users under numerous circumstances.

### BRIEF DESCRIPTION OF THE DRAWINGS

FIG. 1 is a flow chart of a process for organic fertilization using an anaerobic digestate based organic fertilizer product, in accordance with one embodiment;

FIG. 2 is a flow chart of a process for creating an anaerobic digestate based organic fertilizer product from anaerobic digestate and one or more stabilized liquid fish products, in accordance with one embodiment;

FIG. 3 is a flow chart of a process for creating an anaerobic digestate based organic fertilizer product from anaerobic digestate and one or more additives, in accordance with one embodiment;

FIG. 4 is a flow chart of a process for creating an anaerobic digestate based organic fertilizer product from anaerobic digestate and concentrated separator by-product, in accordance with one embodiment; and

FIG. 5 is a flow chart of a process for creating an anaerobic digestate based organic fertilizer product from anaerobic digestate and betaine, in accordance with one embodiment.

Common reference numerals are used throughout the figures and the detailed description to indicate like elements. One skilled in the art will readily recognize that the above figures are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying figures, which depict exemplary embodiments. Embodiments may be embodied in many different forms and should not be construed as limited to the embodiments set forth herein, shown in the figures, and/or described below. Rather, these exemplary embodiments are provided to allow a complete disclosure that conveys the principles of the invention, as set forth in the claims, to those of skill in the art.

In accordance with one embodiment, a process for organic fertilization using anaerobic digestates includes creating an anaerobic digestate based organic fertilizer product and applying the anaerobic digestate based organic fertilizer product to agricultural vegetation and/or the fields/soil/substrate supporting the agricultural vegetation as a method of organic fertilization of the agricultural vegetation.

As used herein, the term “liquid fish products” includes fish hydrolysate and fish soluble by-product. In one embodiment, fish hydrolysate includes enzyme-digested fish, which is created by adding an enzyme that virtually “dissolves” fish by-products into an enzyme digested fish solution. In one embodiment, fish soluble by-product includes a fish by-product resulting from fish and fish parts such as guts, heads, scales, and bones that have been heated, filtered, and stabilized.

The term “stabilized liquid fish products” includes liquid fish products treated with citric acid, sulfuric acid, phosphoric acid, and/or any other stabilizer as known in the art at the time of filing or developed thereafter.

The term “additive” includes concentrated separator by-product; betaine; alfalfa meal; compost; cottonseed meal; kelp and/or seaweed meal; soybean meal; humus; manure; guano; feather meal; blood meal; Chilean nitrate of soda; Epsom salt, greensand; sulfuric acid; sulfate; phosphoric acid; phosphate; calcium sulfate; gypsum; boron; boric acid; calcium phosphate; bone meal; hard-rock phosphate; soft-rock phosphate; calcium carbonate; limestone; and/or any other additives as known in the art at the time of filing and/or as developed after the time of filing. These additives represent significant contributions of nutrients including macronutrients nitrogen, phosphorus, and potassium. In fertilizers, an NPK value represents the relative content of the elements nitrogen, phosphorus, and potassium in a substance. In some instances, it is useful to alter an NPK value to change the ratio or amount of nutrients present in a fertilizer. The combination of one or more additives with anaerobic digestate allows for the alteration of the ratio or amount of nutrients in an anaerobic digestate based organic fertilizer.

The term concentrated separator by-product includes a by-product of the de-sugaring of beet molasses. As a result of this de-sugaring, proteins and minerals in the beet molasses are concentrated to form concentrated separator by-product, which is commonly used as livestock feed. The present Inventor discovered that, contrary to conventional wisdom and practice in the art, heat-treating concentrated separator by-product denatures the heat labile vegetable proteins contained in the concentrated separator by-product sufficiently to allow additional nitrogen to become bioavailable. See Evans, U.S. Pat. No. 7,927,397. Likewise, phosphorous apparently becomes more available as both the original de-sugaring process and the added heat-treatment process break down vegetative nucleosides.

To his surprise, the present Inventor discovered that including heat-treated concentrated separator by-product in fertilizer products resulted in a fertilizer product having significantly increased bioavailable nitrogen, potassium and phosphorous in a readily pumpable, or low viscosity, fluid state.

The term betaine includes an N-trimethylated amino acid produced as a by-product of de-sugaring beet molasses. Betaine has been historically used as a feed additive for many animal species. Despite being readily available, betaine was not considered an economically viable fertilizer component by traditional agricultural teachings because of its initial expense, its relatively small percentage of available nitrogen, and the belief that betaine could not satisfy the USDA National Organic Program regulations to be an organic fertilizer nutrient.

According to this long-standing teaching in the art, the use of betaine as a fertilizer was prohibitively expensive and it was considered more cost effective for a user seeking fertilizer to purchase urea, which contains a higher percentage of nitrogen than betaine, than to purchase betaine. Consequently, given the expense of betaine and its relatively small percentage of nitrogen, traditional agriculture largely ignored betaine as a viable fertilizer. However, as a result of extensive research and experimentation, the Inventor discovered the unexpected result that properly processed, betaine can meet the USDA National Organic Program standards set forth below, and can therefore be used as an organic fertilizer. Once the Inventor realized that betaine can be processed to meet the USDA National Organic Program standards for an organic fertilizer, the Inventor realized that betaine has a special use and special value as an organic nitrogen source and that this discovered property more than justifies its expense.

As used herein, the term “organic fertilizer” means an ingredient or product that may be used in certified organic crop production in accordance with USDA National Organic Program standards.

Currently, 7 CFR 205.203 provides the practice standard for certified organic crop production. The regulations under 7 CFR 205.203 provide the following:

(a) The producer must select and implement tillage and cultivation practices that maintain or improve the physical, chemical, and biological condition of soil and minimize soil erosion.

(b) The producer must manage crop nutrients and soil fertility through rotations, cover crops, and the application of plant and animal materials.

(c) The producer must manage plant and animal materials to maintain or improve soil organic matter content in a manner that does not contribute to contamination of crops, soil, or water by plant nutrients, pathogenic organisms, heavy metals, or residues of prohibited substances. Animal and plant materials include:

(1) Raw animal manure, which must be composted unless it is:

(i) Applied to land used for a crop not intended for human consumption;

(ii) Incorporated into the soil not less than 120 days prior to the harvest of a product whose edible portion has direct contact with the soil surface or soil particles; or

(iii) Incorporated into the soil not less than 90 days prior to the harvest of a product whose edible portion does not have direct contact with the soil surface or soil particles;

(2) Composted plant and animal materials produced through a process that:

(i) Established an initial C:N ratio of between 25:1 and 40:1; and

(ii) Maintained a temperature of between 131° F. and 170° F. for 3 days using an in-vessel or static aerated pile system; or

(iii) Maintained a temperature of between 131° F. and 170° F. for 15 days using a windrow composting system, during which period, the materials must be turned a minimum of five times.

(3) Uncomposted plant materials.

(d) A producer may manage crop nutrients and soil fertility to maintain or improve soil organic matter content in a manner that does not contribute to contamination of crops, soil, or water by plant nutrients, pathogenic organisms, heavy metals, or residues of prohibited substances by applying:

(1) A crop nutrient or soil amendment included on the National List of synthetic substances allowed for use in organic crop production;

(2) A mined substance of low solubility;

(3) A mined substance of high solubility: Provided, That, the substance is used in compliance with the conditions established on the National List of nonsynthetic materials prohibited for crop production;

(4) Ash obtained from the burning of a plant or animal material, except as prohibited in paragraph (e) of this section: Provided, That, the material burned has not been treated or combined with a prohibited substance or the ash is not included on the National List of nonsynthetic substances prohibited for use in organic crop production; and

(5) A plant or animal material that has been chemically altered by a manufacturing process: Provided, that, the material is included on the National List of synthetic substances allowed for use in organic crop production established in §205.601.

(e) The producer must not use:

(1) Any fertilizer or composted plant and animal material that contains a synthetic substance not included on the National List of synthetic substances allowed for use in organic crop production;

(2) Sewage sludge (biosolids) as defined in 40 CFR part 503; and (3) Burning as a means of disposal for crop residues produced on the operation: Except, That, burning may be used to suppress the spread of disease or to stimulate seed germination.

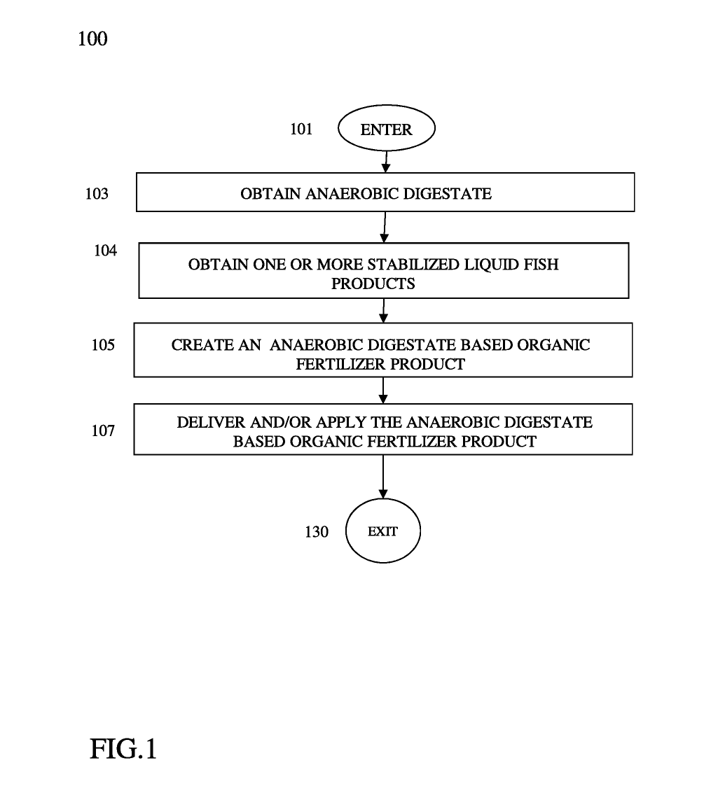

FIG. 1 shows a flow chart of a process for organic fertilization of agricultural vegetation using anaerobic digestate based organic fertilizer 100 in accordance with one embodiment. As shown in FIG. 1, the process for organic fertilization of agricultural vegetation using anaerobic digestate based organic fertilizer 100 begins at ENTER OPERATION 101 and process flow proceeds to OBTAIN ANAEROBIC DIGESTATE OPERATION 103.

In one embodiment, at OBTAIN ANAEROBIC DIGESTATE OPERATION 103, a quantity of anaerobic digestate is obtained.

In one embodiment, once a quantity of anaerobic digestate is obtained at OBTAIN ANAEROBIC DIGESTATE OPERATION 103, process flow proceeds to OBTAIN ONE OR MORE STABILIZED LIQUID FISH PRODUCTS OPERATION 104.

In one embodiment, at OBTAIN ONE OR MORE STABILIZED LIQUID FISH PRODUCTS OPERATION 104, a quantity of one or more stabilized liquid fish products are obtained. In various embodiments, the one or more stabilized liquid fish products include fish soluble by-product and fish hydrolysate that have been pH adjusted with sulfuric, citric, or phosphoric acid. In one embodiment, fish hydrolysate is a thin product containing water resulting from the enzymatic digestion and stabilization of fish waste. In one embodiment, fish soluble by-product includes a fish by-product resulting from fish and fish parts such as guts, heads, scales, and bones that have been heated, filtered, and stabilized. In one embodiment, stabilized liquid fish products can include acidulated fish solubles, acidulated fish tankage, seafood waste, acidulated fish solubles stabilized with phosphoric acid, and acidulated fish and seafood by-product including fish solubles.

In one embodiment, once a quantity of one or more stabilized liquid fish products is obtained at OBTAIN ONE OR MORE STABILIZED LIQUID FISH PRODUCTS OPERATION 104, process flow proceeds to CREATE AN ANAEROBIC DIGESTATE BASED ORGANIC FERTILIZER PRODUCT OPERATION 105.

In one embodiment, at CREATE AN ANAEROBIC DIGESTATE BASED ORGANIC FERTILIZER PRODUCT OPERATION 105, an anaerobic digestate based organic fertilizer product is created. In various embodiments, an anaerobic digestate based organic fertilizer is created by combining the anaerobic digestate of OBTAIN ANAEROBIC DIGESTATE OPERATION 103 and the one or more stabilized liquid fish products of OBTAIN ONE OR MORE STABILIZED LIQUID FISH PRODUCTS OPERATION 104 to create a combination of anaerobic digestate and one or more stabilized liquid fish products. In one embodiment, the combination of anaerobic digestate and one or more stabilized liquid fish products is optionally heat-treated and cooled to yield the anaerobic digestate based organic fertilizer product.

In one embodiment, once an anaerobic digestate based organic fertilizer product is created at CREATE AN ANAEROBIC DIGESTATE BASED ORGANIC FERTILIZER PRODUCT OPERATION 105, process flow proceeds to DELIVER AND/OR APPLY THE ANAEROBIC DIGESTATE BASED ORGANIC FERTILIZER PRODUCT OPERATION 107.

In one embodiment, at DELIVER AND/OR APPLY THE ANAEROBIC DIGESTATE BASED ORGANIC FERTILIZER PRODUCT OPERATION 107, the anaerobic digestate based organic fertilizer product of CREATE AN ANAEROBIC DIGESTATE BASED ORGANIC FERTILIZER PRODUCT OPERATION 105 is transferred in bulk to a tanker truck and/or disposed into drums for delivery of smaller quantities of the anaerobic digestate based organic fertilizer product. In one embodiment, at DELIVER AND/OR APPLY THE ANAEROBIC DIGESTATE BASED ORGANIC FERTILIZER PRODUCT OPERATION 107, the anaerobic digestate based organic fertilizer product of CREATE AN ANAEROBIC DIGESTATE BASED ORGANIC FERTILIZER PRODUCT OPERATION 105 is then delivered to farms for application to agricultural vegetation.

In one embodiment, at DELIVER AND/OR APPLY THE ANAEROBIC DIGESTATE BASED ORGANIC FERTILIZER PRODUCT OPERATION 107, a quantity of the anaerobic digestate based organic fertilizer product of CREATE AN ANAEROBIC DIGESTATE BASED ORGANIC FERTILIZER PRODUCT OPERATION 105 is offloaded into plastic field tanks located at or near the application site. In one embodiment, at DELIVER AND/OR APPLY THE ANAEROBIC DIGESTATE BASED ORGANIC FERTILIZER PRODUCT OPERATION 107, the plastic field tanks are then used to feed the anaerobic digestate based organic fertilizer product of CREATE AN ANAEROBIC DIGESTATE BASED ORGANIC FERTILIZER PRODUCT OPERATION 105 into an irrigation stream either by direct injection or by vacuum drawing from the irrigation flow.

Depending on the particular agricultural vegetation requirements, the application rate of the anaerobic digestate based organic fertilizer product of CREATE AN ANAEROBIC DIGESTATE BASED ORGANIC FERTILIZER PRODUCT OPERATION 105 at DELIVER AND/OR APPLY THE ANAEROBIC DIGESTATE BASED ORGANIC FERTILIZER PRODUCT OPERATION 107 may be anywhere in a range of approximately 5 to 4000 gallons per acre.

In one embodiment, at DELIVER AND/OR APPLY THE ANAEROBIC DIGESTATE BASED ORGANIC FERTILIZER PRODUCT OPERATION 107 the anaerobic digestate based organic fertilizer product of CREATE AN ANAEROBIC DIGESTATE BASED ORGANIC FERTILIZER PRODUCT OPERATION 105 may also be directly sprayed onto the agricultural vegetation without concerns of plant burning as may occur with more concentrated inorganic fertilizers.

In one embodiment, once the anaerobic digestate based organic fertilizer product of CREATE AN ANAEROBIC DIGESTATE BASED ORGANIC FERTILIZER PRODUCT OPERATION 105 is delivered and applied at DELIVER AND/OR APPLY THE ANAEROBIC DIGESTATE BASED ORGANIC FERTILIZER PRODUCT OPERATION 107, process flow proceeds to EXIT OPERATION 130 and the process for organic fertilization of agricultural vegetation using anaerobic digestate 100 is exited.

Using the process for organic fertilization of agricultural vegetation using anaerobic digestate 100, contrary to conventional teachings, an anaerobic digestate based organic fertilizer product is provided that is environmentally benign; is non-pathogenic; is derived from natural organic sources; does not require significant processing; has minimal odor; has a low viscosity liquid form; can be applied directly to agricultural vegetation; can be injected and/or added into irrigation streams; includes time-released nitrogen components which become bioavailable to agricultural vegetation by beneficial microbial digestion in soil; and eliminates chemical crop burning.

In accordance with one embodiment, a process for production of an anaerobic digestate based organic fertilizer product includes combining anaerobic digestate with one or more stabilized liquid fish products. In one embodiment, the combination of anaerobic digestate and one or more stabilized liquid fish products is optionally filtered. In various embodiments, filtering removes suspended particulate matter. In one embodiment, the combination of anaerobic digestate and one or more stabilized liquid fish products is optionally treated. In one embodiment, the heat-treated combination of anaerobic digestate and one or more stabilized liquid fish products is cooled to yield the anaerobic digestate based organic fertilizer product. In one embodiment, the anaerobic digestate based organic fertilizer product is applied to agricultural vegetation, either directly or by inclusion in an irrigation stream.

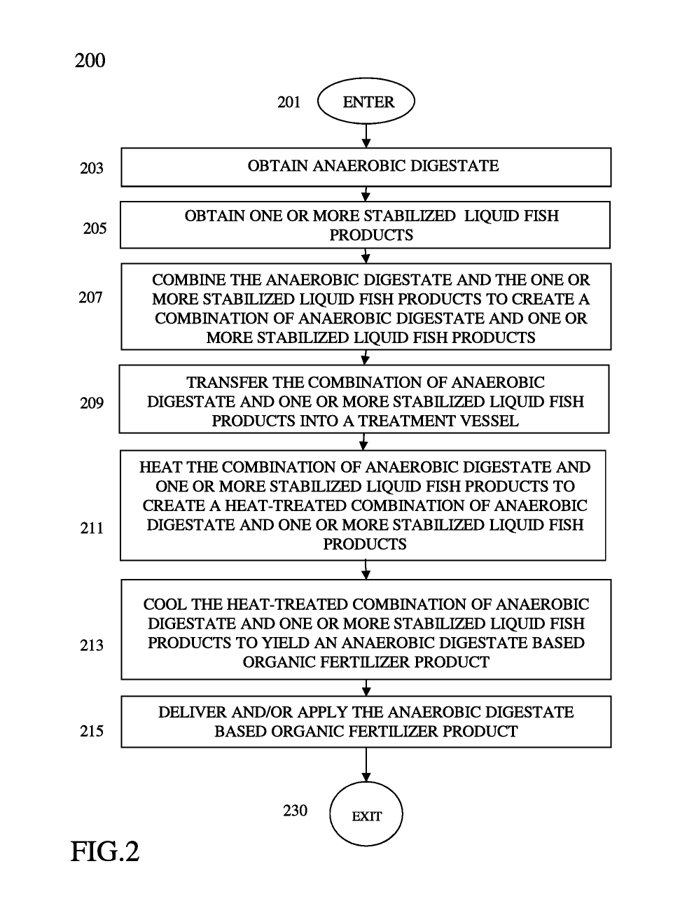

FIG. 2 is a flow chart of a process for creating an anaerobic digestate based organic fertilizer product from anaerobic digestate and one or more stabilized liquid fish products, in accordance with one embodiment. As shown in FIG. 2, a process for production of an anaerobic digestate based organic fertilizer product from anaerobic digestate and one or more stabilized liquid fish products 200 begins at ENTER OPERATION 201 and process flow proceeds to OBTAIN ANAEROBIC DIGESTATE OPERATION 203.

In various embodiments, the anaerobic digestate of OBTAIN ANAEROBIC DIGESTATE OPERATION 203 is, as discussed above, a by-product of anaerobic digestion of waste products such as livestock manure, municipal wastewater solids, food waste, industrial wastewater and residuals, fats, oils, and grease.

In one embodiment, once the anaerobic digestate is obtained at OBTAIN ANAEROBIC DIGESTATE OPERATION 203, process flow proceeds to OBTAIN ONE OR MORE STABILIZED LIQUID FISH PRODUCTS OPERATION 205.

In one embodiment, the one or more stabilized liquid fish products of OBTAIN ONE OR MORE STABILIZED LIQUID FISH PRODUCTS OPERATION 305 include, but are not limited to, fish hydrolysate and fish soluble by-product treated with citric acid, sulfuric acid, phosphoric acid, and/or any other stabilizer as known in the art at the time of filing or developed thereafter.

After one or more stabilized liquid fish products are obtained at OBTAIN ONE OR MORE STABILIZED LIQUID FISH PRODUCTS OPERATION 205, process flow proceeds to COMBINE THE ANAEROBIC DIGESTATE AND THE ONE OR MORE STABILIZED LIQUID FISH PRODUCTS TO CREATE A COMBINATION OF ANAEROBIC DIGESTATE AND ONE OR MORE STABILIZED LIQUID FISH PRODUCTS OPERATION 207, in one embodiment. According to one embodiment, at COMBINE THE ANAEROBIC DIGESTATE AND THE ONE OR MORE STABILIZED LIQUID FISH PRODUCTS TO CREATE A COMBINATION OF ANAEROBIC DIGESTATE AND ONE OR MORE STABILIZED LIQUID FISH PRODUCTS OPERATION 207, at least a portion of the obtained anaerobic digestate and at least of a portion of the obtained one or more stabilized liquid fish products are combined.

In one embodiment, the anaerobic digestate is combined with the one or more stabilized liquid fish products such that the resulting combination of anaerobic digestate and one or more stabilized liquid fish products is 10% to 90% anaerobic digestate. In one embodiment, the anaerobic digestate is combined with the one or more stabilized liquid fish products such that the resulting combination of anaerobic digestate and one or more stabilized liquid fish products is 10% to 90% stabilized liquid fish products.

In other embodiments, at COMBINE THE ANAEROBIC DIGESTATE AND THE ONE OR MORE STABILIZED LIQUID FISH PRODUCTS TO CREATE A COMBINATION OF ANAEROBIC DIGESTATE AND ONE OR MORE STABILIZED LIQUID FISH PRODUCTS OPERATION 207, the anaerobic digestate is combined with the one or more stabilized liquid fish products such that the resulting combination of anaerobic digestate and one or more stabilized liquid fish products is any desired percentage concentration of anaerobic digestate, typically as determined by cost and the specific needs of the user.

In one embodiment, at COMBINE THE ANAEROBIC DIGESTATE AND THE ONE OR MORE STABILIZED LIQUID FISH PRODUCTS TO CREATE A COMBINATION OF ANAEROBIC DIGESTATE AND ONE OR MORE STABILIZED LIQUID FISH PRODUCTS OPERATION 207, the combination of anaerobic digestate and one or more stabilized liquid fish products is optionally filtered. For example, the combination of anaerobic digestate and one or more stabilized liquid fish products may not be filtered if the amount of suspended particulate matter is minimal. If filtration is desired, a stainless steel, or other suitable material, mesh having a mesh size number between 50 and 200 may be employed. In one embodiment, the mesh size is 200.

In one embodiment, combining the anaerobic digestate and the one or more stabilized liquid fish products at COMBINE THE ANAEROBIC DIGESTATE AND THE ONE OR MORE STABILIZED LIQUID FISH PRODUCTS TO CREATE A COMBINATION OF ANAEROBIC DIGESTATE AND ONE OR MORE STABILIZED LIQUID FISH PRODUCTS OPERATION 207 yields the resulting anaerobic digestate based organic fertilizer product.

In one embodiment, once the anaerobic digestate and one or more stabilized liquid fish products are combined at COMBINE THE ANAEROBIC DIGESTATE AND THE ONE OR MORE STABILIZED LIQUID FISH PRODUCTS TO CREATE A COMBINATION OF ANAEROBIC DIGESTATE AND ONE OR MORE STABILIZED LIQUID FISH PRODUCTS OPERATION 207, process flow proceeds to TRANSFER THE COMBINATION OF ANAEROBIC DIGESTATE AND ONE OR MORE STABILIZED LIQUID FISH PRODUCTS INTO A TREATMENT VESSEL OPERATION 209.

In various embodiments, at TRANSFER THE COMBINATION OF ANAEROBIC DIGESTATE AND ONE OR MORE STABILIZED LIQUID FISH PRODUCTS INTO A TREATMENT VESSEL OPERATION 209, at least a portion of the combination of anaerobic digestate and one or more stabilized liquid fish products is transferred into one or more treatment vessels.

In one embodiment, at TRANSFER THE COMBINATION OF ANAEROBIC DIGESTATE AND ONE OR MORE STABILIZED LIQUID FISH PRODUCTS INTO A TREATMENT VESSEL OPERATION 209, the combination of anaerobic digestate and one or more stabilized liquid fish products is filtered as the combination of anaerobic digestate and one or more stabilized liquid fish products is disposed into the treatment vessel. In one embodiment, this filtering is optional. For example, the combination of anaerobic digestate and one or more stabilized liquid fish products may not be filtered if the amount of suspended particulate matter is minimal. If pre-treatment filtration is desired, a stainless steel, or other suitable material, mesh having a mesh size number between 50 and 200 may be employed. In one embodiment, the mesh size is 200.

In one embodiment, once at least a portion of the combination of anaerobic digestate and one or more stabilized liquid fish products is placed in one or more treatment vessels at TRANSFER THE COMBINATION OF ANAEROBIC DIGESTATE AND ONE OR MORE STABILIZED LIQUID FISH PRODUCTS INTO A TREATMENT VESSEL OPERATION 209, process flow proceeds to HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211.

In one embodiment, at HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211, at least a portion of the combination of anaerobic digestate and one or more stabilized liquid fish products of COMBINE THE ANAEROBIC DIGESTATE AND THE ONE OR MORE STABILIZED LIQUID FISH PRODUCTS TO CREATE A COMBINATION OF ANAEROBIC DIGESTATE AND ONE OR MORE STABILIZED LIQUID FISH PRODUCTS OPERATION 207 is mechanically heated.

In one embodiment, at HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211, heat is applied to the combination of anaerobic digestate and one or more stabilized liquid fish products to raise the average temperature of the combination of anaerobic digestate and one or more stabilized liquid fish products to at least 130 degrees F. This temperature range is known to inhibit pathogenic bacterial growth of the most common pathogens such as Escherichia coli O157:H7 and Salmonella.

In one embodiment, at HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211, the combination of anaerobic digestate and one or more stabilized liquid fish products is maintained in the treatment vessel at or above 130 degrees F. for less than 4 hours.

In one embodiment, at HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211, the combination of anaerobic digestate and one or more stabilized liquid fish products is maintained in the treatment vessel at or above 130 degrees F. for at least 4 hours.

In one embodiment, at HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211, the combination of anaerobic digestate and one or more stabilized liquid fish products is maintained in the treatment vessel at or above 130 degrees F. for at least 24 hours to ensure uniform heat transfer to the combination of anaerobic digestate and one or more stabilized liquid fish products.

In one embodiment, the combination of anaerobic digestate and one or more stabilized liquid fish products may be filtered as it is heated at HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211. In one embodiment, the heat-treatment of HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211 may be performed for 120 hours or more, if desired.

In one embodiment, water and/or other liquid may be blended with the combination of anaerobic digestate and one or more stabilized liquid fish products at HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211 to meet the desired nitrogen per weight or volume requirements of the combination of anaerobic digestate and one or more stabilized liquid fish products. In one embodiment, water and/or other liquid may also be used to recover losses due to evaporation during the heat-treatment process of HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211. Liquid blending is typically not required, but is rather an optional procedure.

In one embodiment, if at least a portion of the combination of anaerobic digestate and one or more stabilized liquid fish products of COMBINE THE ANAEROBIC DIGESTATE AND THE ONE OR MORE STABILIZED LIQUID FISH PRODUCTS TO CREATE A COMBINATION OF ANAEROBIC DIGESTATE AND ONE OR MORE STABILIZED LIQUID FISH PRODUCTS OPERATION 207 is optionally heat-treated in the treatment vessel of TRANSFER THE COMBINATION OF ANAEROBIC DIGESTATE AND ONE OR MORE STABILIZED LIQUID FISH PRODUCTS INTO A TREATMENT VESSEL OPERATION 209 at HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211 to create a heat-treated combination of anaerobic digestate and one or more stabilized liquid fish products, process flow proceeds to COOL THE HEAT-TREATED COMBINATION OF ANAEROBIC DIGESTATE AND ONE OR MORE STABILIZED LIQUID FISH PRODUCTS TO YIELD AN ANAEROBIC DIGESTATE BASED ORGANIC FERTILIZER PRODUCT OPERATION 213.

In one embodiment, at COOL THE HEAT-TREATED COMBINATION OF ANAEROBIC DIGESTATE AND ONE OR MORE STABILIZED LIQUID FISH PRODUCTS TO YIELD AN ANAEROBIC DIGESTATE BASED ORGANIC FERTILIZER PRODUCT OPERATION 213, the heat-treated combination of anaerobic digestate and one or more stabilized liquid fish products of HEAT THE COMBINATION OF ANAEROBIC DIGESTATE AND ONE OR MORE STABILIZED LIQUID FISH PRODUCTS TO CREATE A HEAT-TREATED COMBINATION OF ANAEROBIC DIGESTATE AND ONE OR MORE STABILIZED LIQUID FISH PRODUCTS OPERATION 211 is allowed to cool in the treatment vessel of TRANSFER THE COMBINATION OF ANAEROBIC DIGESTATE AND ONE OR MORE STABILIZED LIQUID FISH PRODUCTS INTO A TREATMENT VESSEL OPERATION 209.

As noted, in one embodiment, the cooling at COOL THE HEAT-TREATED COMBINATION OF ANAEROBIC DIGESTATE AND ONE OR MORE STABILIZED LIQUID FISH PRODUCTS TO YIELD AN ANAEROBIC DIGESTATE BASED ORGANIC FERTILIZER PRODUCT OPERATION 213 yields the resulting anaerobic digestate based organic fertilizer product.

In one embodiment, once the heat-treated combination of anaerobic digestate and one or more stabilized liquid fish products is cooled at COOL THE HEAT-TREATED COMBINATION OF ANAEROBIC DIGESTATE AND ONE OR MORE STABILIZED LIQUID FISH PRODUCTS TO YIELD AN ANAEROBIC DIGESTATE BASED ORGANIC FERTILIZER PRODUCT OPERATION 213 to yield the anaerobic digestate based organic fertilizer product, process flow proceeds to DELIVER AND/OR APPLY THE ANAEROBIC DIGESTATE BASED ORGANIC FERTILIZER PRODUCT OPERATION 215.

In one embodiment, once the anaerobic digestate and the one or more stabilized liquid fish products is combined at COMBINE THE ANAEROBIC DIGESTATE AND THE ONE OR MORE STABILIZED LIQUID FISH PRODUCTS TO CREATE A COMBINATION OF ANAEROBIC DIGESTATE AND ONE OR MORE STABILIZED LIQUID FISH PRODUCTS OPERATION 207 to yield the anaerobic digestate based organic fertilizer product, process flow proceeds to DELIVER AND/OR APPLY THE ANAEROBIC DIGESTATE BASED ORGANIC FERTILIZER PRODUCT OPERATION 215.

In one embodiment, at DELIVER AND/OR APPLY THE ANAEROBIC DIGESTATE BASED ORGANIC FERTILIZER PRODUCT OPERATION 215 the anaerobic digestate based organic fertilizer product is transferred in bulk to a tanker truck and/or transferred into drums for delivery of smaller quantities of the anaerobic digestate based organic fertilizer product. In one embodiment, at DELIVER AND/OR APPLY THE ANAEROBIC DIGES TATE BASED ORGANIC FERTILIZER PRODUCT OPERATION 215, the anaerobic digestate based organic fertilizer product is then delivered to farms for application to agricultural vegetation.

In one embodiment, at DELIVER AND/OR APPLY THE ANAEROBIC DIGESTATE BASED ORGANIC FERTILIZER PRODUCT OPERATION 215, a quantity of the anaerobic digestate based organic fertilizer product is offloaded into plastic field tanks located at or near the application site. In one embodiment, at DELIVER AND/OR APPLY THE ANAEROBIC DIGESTATE BASED ORGANIC FERTILIZER PRODUCT OPERATION 215, the plastic field tanks are then used to feed the anaerobic digestate based organic fertilizer product into the irrigation stream either by direct injection or by vacuum drawing from the irrigation flow.

Depending on the particular agricultural vegetation requirements, the application rate of anaerobic digestate based organic fertilizer product at DELIVER AND/OR APPLY THE ANAEROBIC DIGESTATE BASED ORGANIC FERTILIZER PRODUCT OPERATION 215 may be anywhere in a range of approximately 5 to 4000 gallons per acre.

In one embodiment, at DELIVER AND/OR APPLY THE ANAEROBIC DIGESTATE BASED ORGANIC FERTILIZER PRODUCT OPERATION 215, the anaerobic digestate based organic fertilizer product may also be directly sprayed onto the agricultural vegetation without concerns of plant burning as may occur with more concentrated inorganic fertilizers.

In one embodiment, once the anaerobic digestate based organic fertilizer product is delivered and applied at DELIVER AND/OR APPLY THE ANAEROBIC DIGESTATE BASED ORGANIC FERTILIZER PRODUCT OPERATION 215, process flow proceeds to EXIT OPERATION 230 and the process for production of an anaerobic digestate based organic fertilizer product from anaerobic digestate and one or more stabilized liquid fish products 200 is exited.

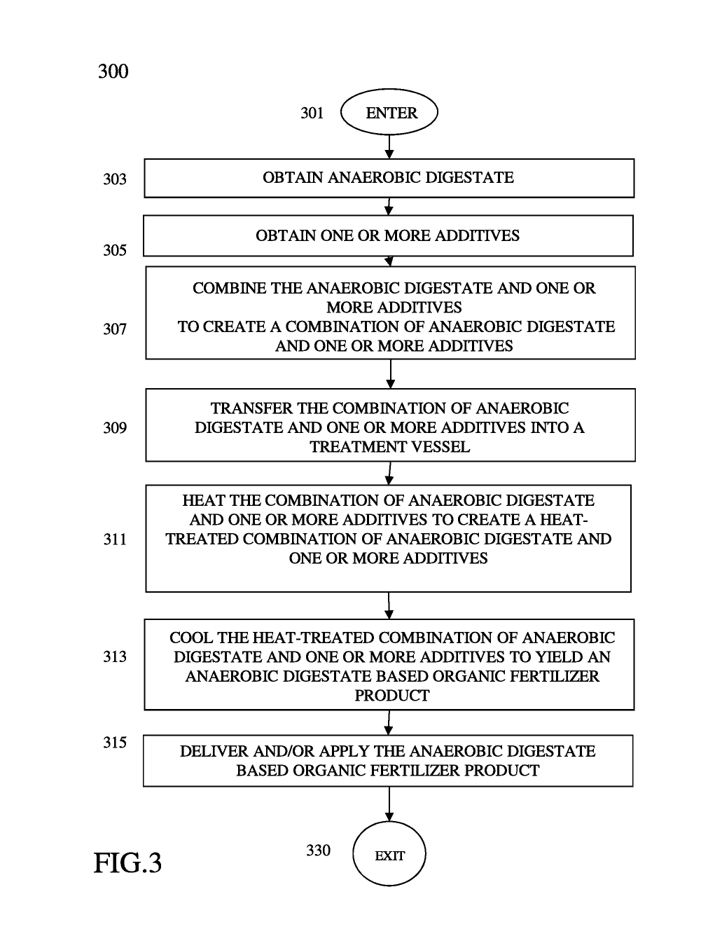

FIG. 3 is a flow chart of a process for creating an anaerobic digestate based organic fertilizer product from anaerobic digestate and one or more additives, in accordance with one embodiment. As shown in FIG. 3, a process for production of an anaerobic digestate based organic fertilizer product from anaerobic digestate and one or more additives 300 begins at ENTER OPERATION 301 and process flow proceeds to OBTAIN ANAEROBIC DIGESTATE OPERATION 303.

The anaerobic digestate of OBTAIN ANAEROBIC DIGESTATE OPERATION 303 is, as discussed above, a by-product of anaerobic digestion of waste products. In one embodiment, the anaerobic digestate of OBTAIN ANAEROBIC DIGESTATE OPERATION 303 is combined with one or more stabilized liquid fish products, as discussed in FIG. 2.

In one embodiment, once the anaerobic digestate is obtained at OBTAIN ANAEROBIC DIGESTATE OPERATION 303, process flow proceeds to OBTAIN ONE OR MORE ADDITIVES OPERATION 305.

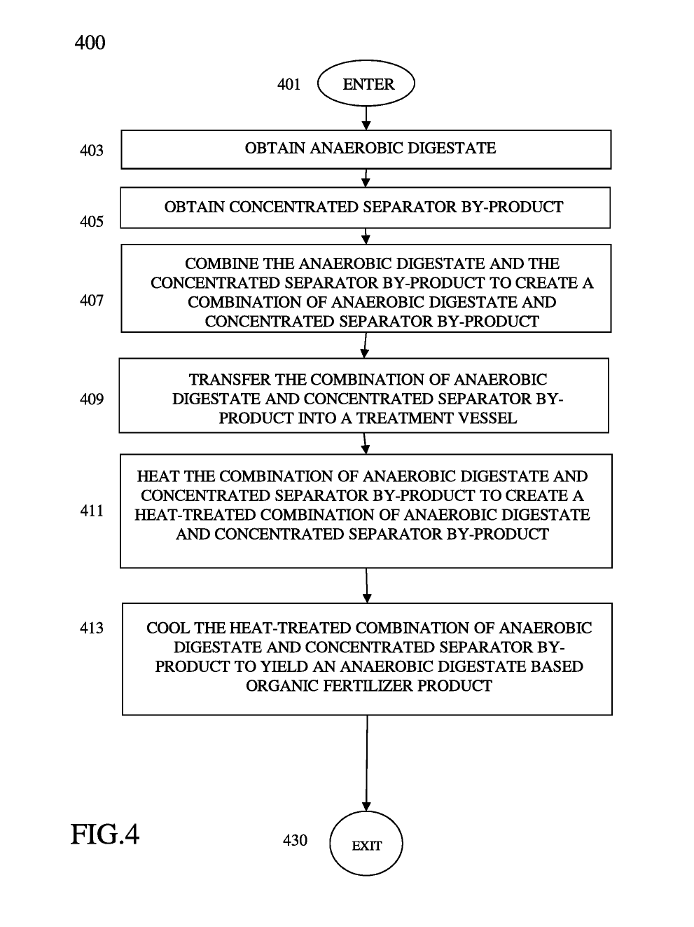

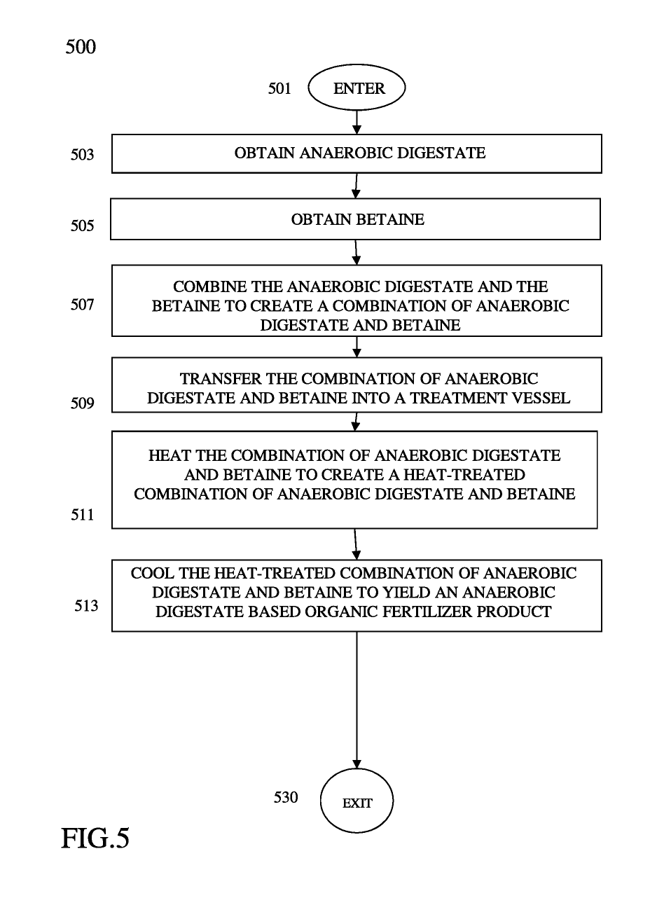

The one or more additives of OBTAIN ONE OR MORE ADDITIVES OPERATION 305 include, but are not limited to, one or more of the following: concentrated separator by-product; betaine; and/or any other additive as known in the industry at or after the time of filing. In one embodiment, the one or more additives include concentrated separator by-product. In one embodiment, the one or more additives include betaine. In one embodiment, the one or more additives include betaine and concentrated separator by-product. Concentrated separator by-product and betaine are each discussed in more detail in FIGS. 4, and 5, respectively.

After one or more additives are obtained at OBTAIN ONE OR MORE ADDITIVES OPERATION 305, process flow proceeds to COMBINE THE ANAEROBIC DIGESTATE AND THE ONE OR MORE ADDITIVES TO CREATE A COMBINATION OF ANAEROBIC DIGESTATE AND ONE OR MORE ADDITIVES OPERATION 307, in one embodiment. According to one embodiment, at COMBINE THE ANAEROBIC DIGESTATE AND THE ONE OR MORE ADDITIVES TO CREATE A COMBINATION OF ANAEROBIC DIGESTATE AND ONE OR MORE ADDITIVES OPERATION 307, at least a portion of the obtained anaerobic digestate and at least of a portion of the obtained one or more additives are combined.

In one embodiment, the anaerobic digestate is combined with the one or more additives such that the resulting combination of anaerobic digestate and one or more additives is 10% to 90% anaerobic digestate. In one embodiment, the anaerobic digestate is combined with the one or more additives such that the resulting combination of anaerobic digestate and one or more additives is 10% to 90% additives.

In other embodiments, at COMBINE THE ANAEROBIC DIGESTATE AND THE ONE OR MORE ADDITIVES TO CREATE A COMBINATION OF ANAEROBIC DIGESTATE AND ONE OR MORE ADDITIVES OPERATION 307, the anaerobic digestate is combined with the one or more additives such that the resulting combination of anaerobic digestate and one or more additives is any desired percentage concentration of anaerobic digestate, typically as determined by cost and the specific needs of the user.

In one embodiment, at COMBINE THE ANAEROBIC DIGESTATE AND THE ONE OR MORE ADDITIVES TO CREATE A COMBINATION OF ANAEROBIC DIGESTATE AND ONE OR MORE ADDITIVES OPERATION 307, the combination of the anaerobic digestate and the one or more additives is optionally filtered. In one embodiment, a mesh having a mesh size number between 50 and 200 is used to filter the combination of the anaerobic digestate and the one or more additives. In one embodiment, combining the anaerobic digestate and the one or more additives at COMBINE THE ANAEROBIC DIGESTATE AND THE ONE OR MORE ADDITIVES TO CREATE A COMBINATION OF ANAEROBIC DIGESTATE AND ONE OR MORE ADDITIVES OPERATION 307 yields the resulting anaerobic digestate based organic fertilizer product.

In one embodiment, once the anaerobic digestate and one or more additives are combined at COMBINE THE ANAEROBIC DIGESTATE AND THE ONE OR MORE ADDITIVES TO CREATE A COMBINATION OF ANAEROBIC DIGESTATE AND ONE OR MORE ADDITIVES OPERATION 307, process flow proceeds to TRANSFER THE COMBINATION OF ANAEROBIC DIGESTATE AND ONE OR MORE ADDITIVES INTO A TREATMENT VESSEL OPERATION 309.

In various embodiments, at TRANSFER THE COMBINATION OF ANAEROBIC DIGESTATE AND ONE OR MORE ADDITIVES INTO A TREATMENT VESSEL OPERATION 309, at least a portion of the combination of anaerobic digestate and one or more additives is transferred into one or more treatment vessels.

In one embodiment, at TRANSFER THE COMBINATION OF ANAEROBIC DIGESTATE AND ONE OR MORE ADDITIVES INTO A TREATMENT VESSEL OPERATION 309, the combination of anaerobic digestate and one or more additives is filtered as the combination of anaerobic digestate and one or more additives is disposed into the treatment vessel. In one embodiment, this filtering is optional. For example, the combination of anaerobic digestate and one or more additives may not be filtered if the amount of suspended particulate matter is minimal. If pre-treatment filtration is desired, a stainless steel, or other suitable material, mesh having a mesh size number between 50 and 200 may be employed. In one embodiment, the mesh size is 200.

In one embodiment, once at least a portion of the combination of anaerobic digestate and one or more additives is placed in one or more treatment vessels at TRANSFER THE COMBINATION OF ANAEROBIC DIGESTATE AND ONE OR MORE ADDITIVES INTO A TREATMENT VESSEL OPERATION 309, process flow proceeds to HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311.

In one embodiment, at HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311, at least a portion of the combination of anaerobic digestate and one or more additives of COMBINE THE ANAEROBIC DIGESTATE AND THE ONE OR MORE ADDITIVES TO CREATE A COMBINATION OF ANAEROBIC DIGESTATE AND ONE OR MORE ADDITIVES OPERATION 307 is mechanically heated.

In one embodiment, at HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311, heat is applied to the combination of anaerobic digestate and one or more additives to raise the average temperature of the combination of anaerobic digestate and one or more additives to at least 130 degrees F. This temperature range is known to inhibit pathogenic bacterial growth of the most common pathogens such as Escherichia coli O157:H7 and Salmonella.

In one embodiment, at HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311, the combination of anaerobic digestate and one or more additives is maintained in the treatment vessel at or above 130 degrees F. for less than 4 hours. In one embodiment, at HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311, the combination of anaerobic digestate and one or more additives is maintained in the treatment vessel at or above 130 degrees F. for at least 4 hours. In one embodiment, at HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311, the combination of anaerobic digestate and one or more additives is maintained in the treatment vessel at or above 130 degrees F. for at least 24 hours to ensure uniform heat transfer to the combination of anaerobic digestate and one or more additives. In one embodiment, the combination of anaerobic digestate and one or more additives may be filtered as it is heated at HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311 as part of the treatment process. In one embodiment, the heat-treatment of HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311 may be performed for 120 hours or more, if desired.

In one embodiment, water and/or other liquid may be blended with the combination of anaerobic digestate and one or more additives at HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311 to meet the desired nitrogen per weight or volume requirements of the combination of anaerobic digestate and one or more additives. In one embodiment, water and/or other liquid may also be used to recover losses due to evaporation during the heat-treatment process of HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311. Liquid blending is typically not required, but is rather an optional procedure.

In one embodiment, if at least a portion of the combination of anaerobic digestate and one or more additives of COMBINE THE ANAEROBIC DIGESTATE AND THE ONE OR MORE ADDITIVES TO CREATE A COMBINATION OF ANAEROBIC DIGESTATE AND ONE OR MORE ADDITIVES OPERATION 307 is optionally treated in the treatment vessel of TRANSFER THE COMBINATION OF ANAEROBIC DIGESTATE AND ONE OR MORE ADDITIVES INTO A TREATMENT VESSEL OPERATION 309 at HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311 to create a heat-treated combination of anaerobic digestate and one or more additives, process flow proceeds to COOL THE HEAT-TREATED COMBINATION OF ANAEROBIC DIGESTATE AND ONE OR MORE ADDITIVES TO YIELD AN ANAEROBIC DIGESTATE BASED ORGANIC FERTILIZER PRODUCT OPERATION 313.

In one embodiment, at COOL THE HEAT-TREATED COMBINATION OF ANAEROBIC DIGESTATE AND ONE OR MORE ADDITIVES TO YIELD AN ANAEROBIC DIGESTATE BASED ORGANIC FERTILIZER PRODUCT OPERATION 313, the heat-treated combination of anaerobic digestate and one or more additives of HEAT THE COMBINATION OF ANAEROBIC DIGESTATE AND ONE OR MORE ADDITIVES TO CREATE A HEAT-TREATED COMBINATION OF ANAEROBIC DIGESTATE AND ONE OR MORE ADDITIVES OPERATION 311 is allowed to cool in the treatment vessel of TRANSFER THE COMBINATION OF ANAEROBIC DIGESTATE AND ONE OR MORE ADDITIVES INTO A TREATMENT VESSEL OPERATION 309.

As noted, in one embodiment, the cooling at COOL THE HEAT-TREATED COMBINATION OF ANAEROBIC DIGESTATE AND ONE OR MORE ADDITIVES TO YIELD AN ANAEROBIC DIGESTATE BASED ORGANIC FERTILIZER PRODUCT OPERATION 313 yields the resulting anaerobic digestate based organic fertilizer product.

In one embodiment, once the heat-treated combination of anaerobic digestate and one or more additives is cooled at COOL THE HEAT-TREATED COMBINATION OF ANAEROBIC DIGESTATE AND ONE OR MORE ADDITIVES TO YIELD AN ANAEROBIC DIGESTATE BASED ORGANIC FERTILIZER PRODUCT OPERATION 313 to yield the anaerobic digestate based organic fertilizer product, process flow proceeds to DELIVER AND/OR APPLY THE ANAEROBIC DIGESTATE BASED ORGANIC FERTILIZER PRODUCT OPERATION 315.

In one embodiment, once the anaerobic digestate and the one or more additives is combined at COMBINE THE ANAEROBIC DIGESTATE AND THE ONE OR MORE ADDITIVES TO CREATE A COMBINATION OF ANAEROBIC DIGESTATE AND ONE OR MORE ADDITIVES OPERATION 307 to yield the resulting anaerobic digestate based organic fertilizer product, process flow proceeds to DELIVER AND/OR APPLY THE ANAEROBIC DIGESTATE BASED ORGANIC FERTILIZER PRODUCT OPERATION 315.

In one embodiment, at DELIVER AND/OR APPLY THE ANAEROBIC DIGESTATE BASED ORGANIC FERTILIZER PRODUCT OPERATION 315 the anaerobic digestate based organic fertilizer product is transferred in bulk to a tanker truck and/or transferred into drums for delivery of smaller quantities of the anaerobic digestate based organic fertilizer product. In one embodiment, at DELIVER AND/OR APPLY THE ANAEROBIC DIGES TATE BASED ORGANIC FERTILIZER PRODUCT OPERATION 315, the anaerobic digestate based organic fertilizer product is then delivered to farms for application to agricultural vegetation.

In one embodiment, at DELIVER AND/OR APPLY THE ANAEROBIC DIGESTATE BASED ORGANIC FERTILIZER PRODUCT OPERATION 315, a quantity of the anaerobic digestate based organic fertilizer product is offloaded into plastic field tanks located at or near the application site. In one embodiment, at DELIVER AND/OR APPLY THE ANAEROBIC DIGESTATE BASED ORGANIC FERTILIZER PRODUCT OPERATION 315, the plastic field tanks are then used to feed the anaerobic digestate based organic fertilizer product into the irrigation stream either by direct injection or by vacuum drawing from the irrigation flow.

Depending on the particular agricultural vegetation requirements, the application rate of anaerobic digestate based organic fertilizer product at DELIVER AND/OR APPLY THE ANAEROBIC DIGESTATE BASED ORGANIC FERTILIZER PRODUCT OPERATION 315 may be anywhere in a range of approximately 5 to 4000 gallons per acre.

In one embodiment, at DELIVER AND/OR APPLY THE ANAEROBIC DIGESTATE BASED ORGANIC FERTILIZER PRODUCT OPERATION 315, the anaerobic digestate based organic fertilizer product may also be directly sprayed onto the agricultural vegetation without concerns of plant burning as may occur with more concentrated inorganic fertilizers.

In one embodiment, once the anaerobic digestate based organic fertilizer product is delivered and applied at DELIVER AND/OR APPLY THE ANAEROBIC DIGESTATE BASED ORGANIC FERTILIZER PRODUCT OPERATION 315, process flow proceeds to EXIT OPERATION 330 and the process for production of an anaerobic digestate based organic fertilizer product from anaerobic digestate and one or more additives 300 is exited.

FIG. 4 is a flow chart of a process for creating an anaerobic digestate based organic fertilizer product from anaerobic digestate and concentrated separator by-product, in accordance with one embodiment. As shown in FIG. 4, a process for production of an anaerobic digestate based organic fertilizer product from anaerobic digestate and concentrated separator by-product 400 begins at ENTER OPERATION 401 and process flow proceeds to OBTAIN ANAEROBIC DIGESTATE OPERATION 403.

The anaerobic digestate of OBTAIN ANAEROBIC DIGESTATE OPERATION 403 is, as discussed above, a by-product of anaerobic digestion of waste products. In one embodiment, once the anaerobic digestate is obtained at OBTAIN ANAEROBIC DIGESTATE OPERATION 403, process flow proceeds to OBTAIN CONCENTRATED SEPARATOR BY-PRODUCT OPERATION 405.

In one embodiment, the concentrated separator by-product of OBTAIN CONCENTRATED SEPARATOR BY-PRODUCT OPERATION 405 is a by-product of the de-sugaring of beet molasses and therefore readily available. Currently, concentrated separator by-product is commonly used as a feed source for livestock.

After concentrated separator by-product is obtained at OBTAIN CONCENTRATED SEPARATOR BY-PRODUCT OPERATION 405, process flow proceeds to COMBINE THE ANAEROBIC DIGESTATE AND THE CONCENTRATED SEPARATOR BY-PRODUCT TO CREATE A COMBINATION OF ANAEROBIC DIGESTATE AND CONCENTRATED SEPARATOR BY-PRODUCT OPERATION 407, in one embodiment. According to one embodiment, at COMBINE THE ANAEROBIC DIGESTATE AND THE CONCENTRATED SEPARATOR BY-PRODUCT TO CREATE A COMBINATION OF ANAEROBIC DIGESTATE AND CONCENTRATED SEPARATOR BY-PRODUCT OPERATION 407, at least a portion of the obtained anaerobic digestate and at least of a portion of the obtained concentrated separator by-product are combined.

In one embodiment, the anaerobic digestate is combined with the concentrated separator by-product such that the resulting combination of anaerobic digestate and concentrated separator by-product is 10% to 90% anaerobic digestate. In one embodiment, the anaerobic digestate is combined with the concentrated separator by-product such that the resulting combination of anaerobic digestate and concentrated separator by-product is 10% to 90% concentrated separator by-product.

In other embodiments, at COMBINE THE ANAEROBIC DIGESTATE AND THE CONCENTRATED SEPARATOR BY-PRODUCT TO CREATE A COMBINATION OF ANAEROBIC DIGESTATE AND CONCENTRATED SEPARATOR BY-PRODUCT OPERATION 407, the anaerobic digestate is combined with the concentrated separator by-product such that the resulting combination of anaerobic digestate and concentrated separator by-product is any desired percentage concentration of anaerobic digestate, typically as determined by cost and the specific needs of the user.

In one embodiment, at COMBINE THE ANAEROBIC DIGESTATE AND THE CONCENTRATED SEPARATOR BY-PRODUCT TO CREATE A COMBINATION OF ANAEROBIC DIGESTATE AND CONCENTRATED SEPARATOR BY-PRODUCT OPERATION 407, the combination of anaerobic digestate and concentrated separator by-product is optionally filtered. In one embodiment, combining the anaerobic digestate and the concentrated separator by-product at COMBINE THE ANAEROBIC DIGESTATE AND THE CONCENTRATED SEPARATOR BY-PRODUCT TO CREATE A COMBINATION OF ANAEROBIC DIGESTATE AND CONCENTRATED SEPARATOR BY-PRODUCT OPERATION 407 yields the resulting anaerobic digestate based organic fertilizer.

In one embodiment, once the anaerobic digestate and the concentrated separator by-product is combined at COMBINE THE ANAEROBIC DIGESTATE AND THE CONCENTRATED SEPARATOR BY-PRODUCT TO CREATE A COMBINATION OF ANAEROBIC DIGESTATE AND CONCENTRATED SEPARATOR BY-PRODUCT OPERATION 407 to yield the anaerobic digestate based organic fertilizer product, process flow proceeds to EXIT OPERATION 430 and the process for production of an anaerobic digestate based organic fertilizer product from anaerobic digestate and concentrated separator by-product 400 is exited.

In one embodiment, once the anaerobic digestate and concentrated separator by-product are combined at COMBINE THE ANAEROBIC DIGESTATE AND THE CONCENTRATED SEPARATOR BY-PRODUCT TO CREATE A COMBINATION OF ANAEROBIC DIGESTATE AND CONCENTRATED SEPARATOR BY-PRODUCT OPERATION 407, process flow proceeds to TRANSFER THE COMBINATION OF ANAEROBIC DIGESTATE AND CONCENTRATED SEPARATOR BY-PRODUCT INTO A TREATMENT VESSEL OPERATION 409.

In various embodiments, at TRANSFER THE COMBINATION OF ANAEROBIC DIGESTATE AND CONCENTRATED SEPARATOR BY-PRODUCT INTO A TREATMENT VESSEL OPERATION 409, at least a portion of the combination of anaerobic digestate and concentrated separator by-product is transferred into one or more treatment vessels.

In one embodiment, at TRANSFER THE COMBINATION OF ANAEROBIC DIGESTATE AND CONCENTRATED SEPARATOR BY-PRODUCT INTO A TREATMENT VESSEL OPERATION 409, the combination of anaerobic digestate and concentrated separator by-product is filtered as the combination of anaerobic digestate and concentrated separator by-product is disposed into the treatment vessel. In one embodiment, this filtering is optional. If pre-treatment filtration is desired, a stainless steel, or other suitable material, mesh having a mesh size number between 50 and 200 may be employed. In one embodiment, the mesh size is 200.

In one embodiment, once at least a portion of the combination of anaerobic digestate and concentrated separator by-product is placed in one or more treatment vessels at TRANSFER THE COMBINATION OF ANAEROBIC DIGESTATE AND CONCENTRATED SEPARATOR BY-PRODUCT INTO A TREATMENT VESSEL OPERATION 409, process flow proceeds to HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411.

In one embodiment, at HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411, at least a portion of the combination of anaerobic digestate and concentrated separator by-product of COMBINE THE ANAEROBIC DIGESTATE AND THE CONCENTRATED SEPARATOR BY-PRODUCT TO CREATE A COMBINATION OF ANAEROBIC DIGESTATE AND CONCENTRATED SEPARATOR BY-PRODUCT OPERATION 407 is mechanically heated.

In one embodiment, at HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411, heat is applied to the combination of anaerobic digestate and concentrated separator by-product to raise the average temperature of the combination of anaerobic digestate and concentrated separator by-product to at least 130 degrees F.

In one embodiment, at HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411, the combination of anaerobic digestate and concentrated separator by-product is maintained in the treatment vessel at or above 130 degrees F. for less than 4 hours. In one embodiment, at HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411, the combination of anaerobic digestate and concentrated separator by-product is maintained in the treatment vessel at or above 130 degrees F. for at least 4 hours. In one embodiment, at HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411, the combination of anaerobic digestate and concentrated separator by-product is maintained in the treatment vessel at or above 130 degrees F. for at least 24 hours to ensure uniform heat transfer to the combination of anaerobic digestate and concentrated separator by-product. In one embodiment, the combination of anaerobic digestate and concentrated separator by-product may be filtered as it is heated at HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411. In one embodiment, the heat-treatment of HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411 may be performed for 120 hours or more, if desired.

In one embodiment, water may be blended with the combination of anaerobic digestate and concentrated separator by-product at HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411 to meet the desired nitrogen per weight or volume requirements of the combination of concentrated separator by-product and anaerobic digestate. In one embodiment, water may also be used to recover losses due to evaporation during the heat-treatment process of HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411.

In one embodiment, if at least a portion of the combination of anaerobic digestate and concentrated separator by-product of COMBINE THE ANAEROBIC DIGESTATE AND THE CONCENTRATED SEPARATOR BY-PRODUCT TO CREATE A COMBINATION OF ANAEROBIC DIGESTATE AND CONCENTRATED SEPARATOR BY-PRODUCT OPERATION 407 is optionally treated in the treatment vessel of TRANSFER THE COMBINATION OF ANAEROBIC DIGESTATE AND CONCENTRATED SEPARATOR BY-PRODUCT INTO A TREATMENT VESSEL OPERATION 409 at HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411 to create a heat-treated combination of anaerobic digestate and concentrated separator by-product, process flow proceeds to COOL THE HEAT-TREATED COMBINATION OF ANAEROBIC DIGESTATE AND CONCENTRATED SEPARATOR BY-PRODUCT TO YIELD AN ANAEROBIC DIGESTATE BASED ORGANIC FERTILIZER PRODUCT OPERATION 413.

In one embodiment, at COOL THE HEAT-TREATED COMBINATION OF ANAEROBIC DIGESTATE AND CONCENTRATED SEPARATOR BY-PRODUCT TO YIELD AN ANAEROBIC DIGESTATE BASED ORGANIC FERTILIZER PRODUCT OPERATION 413, the heat-treated combination of anaerobic digestate and concentrated separator by-product of HEAT THE COMBINATION OF ANAEROBIC DIGESTATE AND CONCENTRATED SEPARATOR BY-PRODUCT TO CREATE A HEAT-TREATED COMBINATION OF ANAEROBIC DIGESTATE AND CONCENTRATED SEPARATOR BY-PRODUCT OPERATION 411 is allowed to cool in the treatment vessel of TRANSFER THE COMBINATION OF ANAEROBIC DIGESTATE AND CONCENTRATED SEPARATOR BY-PRODUCT INTO A TREATMENT VESSEL OPERATION 409.

As noted, in one embodiment, the cooling at COOL THE HEAT-TREATED COMBINATION OF ANAEROBIC DIGESTATE AND CONCENTRATED SEPARATOR BY-PRODUCT TO YIELD AN ANAEROBIC DIGESTATE BASED ORGANIC FERTILIZER PRODUCT OPERATION 413 yields the resulting anaerobic digestate based organic fertilizer product.

In one embodiment, once the heat-treated combination of anaerobic digestate and concentrated separator by-product is cooled at COOL THE HEAT-TREATED COMBINATION OF ANAEROBIC DIGESTATE AND CONCENTRATED SEPARATOR BY-PRODUCT TO YIELD AN ANAEROBIC DIGESTATE BASED ORGANIC FERTILIZER PRODUCT OPERATION 413 to yield the anaerobic digestate based organic fertilizer product, process flow proceeds to EXIT OPERATION 430 and the process for production of an anaerobic digestate based organic fertilizer product from anaerobic digestate and concentrated separator by-product 400 is exited.

FIG. 5 is a flow chart of a process for creating an anaerobic digestate based organic fertilizer product from anaerobic digestate and betaine, in accordance with one embodiment. As shown in FIG. 5, a process for production of an anaerobic digestate based organic fertilizer product from anaerobic digestate and betaine 500 begins at ENTER OPERATION 501 and process flow proceeds to OBTAIN ANAEROBIC DIGESTATE OPERATION 503.

The anaerobic digestate of OBTAIN ANAEROBIC DIGESTATE OPERATION 503 is, as discussed above, a by-product of anaerobic digestion of waste products. In one embodiment, once the anaerobic digestate is obtained at OBTAIN ANAEROBIC DIGESTATE OPERATION 503, process flow proceeds to OBTAIN BETAINE OPERATION 505.

In one embodiment, the betaine of OBTAIN BETAINE OPERATION 505 is an N-trimethylated amino acid produced as a by-product of de-sugaring beet molasses. After betaine is obtained at OBTAIN BETAINE OPERATION 505, process flow proceeds to COMBINE THE ANAEROBIC DIGESTATE AND THE BETAINE TO CREATE A COMBINATION OF ANAEROBIC DIGESTATE AND BETAINE OPERATION 507, in one embodiment. According to one embodiment, at COMBINE THE ANAEROBIC DIGESTATE AND THE BETAINE TO CREATE A COMBINATION OF ANAEROBIC DIGESTATE AND BETAINE OPERATION 507, at least a portion of the obtained anaerobic digestate and at least of a portion of the obtained betaine are combined.

In one embodiment, the anaerobic digestate is combined with the betaine such that the resulting combination of anaerobic digestate and betaine is 10% to 90% anaerobic digestate. In one embodiment, the anaerobic digestate is combined with the betaine such that the resulting combination of anaerobic digestate and betaine is 10% to 90% betaine.

In other embodiments, at COMBINE THE ANAEROBIC DIGESTATE AND THE BETAINE TO CREATE A COMBINATION OF ANAEROBIC DIGESTATE AND BETAINE OPERATION 507, the anaerobic digestate is combined with the betaine such that the resulting combination of anaerobic digestate and betaine is any desired percentage concentration of anaerobic digestate, typically as determined by cost and the specific needs of the user.

In one embodiment, at COMBINE THE ANAEROBIC DIGESTATE AND THE BETAINE TO CREATE A COMBINATION OF ANAEROBIC DIGESTATE AND BETAINE OPERATION 507, the combination of anaerobic digestate and betaine is optionally filtered.

In one embodiment, combining the anaerobic digestate and the betaine at COMBINE THE ANAEROBIC DIGESTATE AND THE BETAINE TO CREATE A COMBINATION OF ANAEROBIC DIGESTATE AND BETAINE OPERATION 507 yields the resulting anaerobic digestate based organic fertilizer product.

In one embodiment, once the anaerobic digestate and the betaine is combined at COMBINE THE ANAEROBIC DIGESTATE AND THE BETAINE TO CREATE A COMBINATION OF ANAEROBIC DIGESTATE AND BETAINE OPERATION 507 to yield the anaerobic digestate based organic fertilizer product, process flow proceeds to EXIT OPERATION 530 and the process for production of an anaerobic digestate based organic fertilizer product from anaerobic digestate and betaine 500 is exited.

In one embodiment, once the anaerobic digestate and betaine are combined at COMBINE THE ANAEROBIC DIGESTATE AND THE BETAINE TO CREATE A COMBINATION OF ANAEROBIC DIGESTATE AND BETAINE OPERATION 507, process flow proceeds to TRANSFER THE COMBINATION OF ANAEROBIC DIGESTATE AND BETAINE INTO A TREATMENT VESSEL OPERATION 509.

In various embodiments, at TRANSFER THE COMBINATION OF ANAEROBIC DIGESTATE AND BETAINE INTO A TREATMENT VESSEL OPERATION 509, at least a portion of the combination of anaerobic digestate and betaine is transferred into one or more treatment vessels.

In one embodiment, at TRANSFER THE COMBINATION OF ANAEROBIC DIGESTATE AND BETAINE INTO A TREATMENT VESSEL OPERATION 509, the combination of anaerobic digestate and betaine is filtered as the combination of anaerobic digestate and betaine is disposed into the treatment vessel. If pre-treatment filtration is desired, a stainless steel, or other suitable material, mesh having a mesh size number between 50 and 200 may be employed. In one embodiment, the mesh size is 200.

In one embodiment, once at least a portion of the combination of anaerobic digestate and betaine is placed in one or more treatment vessels at TRANSFER THE COMBINATION OF ANAEROBIC DIGESTATE AND BETAINE INTO A TREATMENT VESSEL OPERATION 509, process flow proceeds to HEAT THE COMBINATION OF ANAEROBIC DIGESTATE AND BETAINE TO CREATE A HEAT-TREATED COMBINATION OF ANAEROBIC DIGESTATE AND BETAINE OPERATION 511.

In one embodiment, at HEAT THE COMBINATION OF ANAEROBIC DIGESTATE AND BETAINE TO CREATE A HEAT-TREATED COMBINATION OF ANAEROBIC DIGESTATE AND BETAINE OPERATION 511, at least a portion of the combination of anaerobic digestate and betaine of COMBINE THE ANAEROBIC DIGESTATE AND THE BETAINE TO CREATE A COMBINATION OF ANAEROBIC DIGESTATE AND BETAINE OPERATION 507 is mechanically heated.

In one embodiment, at HEAT THE COMBINATION OF ANAEROBIC DIGESTATE AND BETAINE TO CREATE A HEAT-TREATED COMBINATION OF ANAEROBIC DIGESTATE AND BETAINE OPERATION 511, heat is applied to the combination of anaerobic digestate and betaine to raise the average temperature of the combination of anaerobic digestate and betaine to at least 130 degrees F.

In one embodiment, at HEAT THE COMBINATION OF ANAEROBIC DIGESTATE AND BETAINE TO CREATE A HEAT-TREATED COMBINATION OF ANAEROBIC DIGESTATE AND BETAINE OPERATION 511, the combination of anaerobic digestate and betaine is maintained in the treatment vessel at or above 130 degrees F. for less than 4 hours. In one embodiment, at HEAT THE COMBINATION OF ANAEROBIC DIGESTATE AND BETAINE TO CREATE A HEAT-TREATED COMBINATION OF ANAEROBIC DIGESTATE AND BETAINE OPERATION 511, the combination of anaerobic digestate and betaine is maintained in the treatment vessel at or above 130 degrees F. for at least 4 hours. In one embodiment, at HEAT THE COMBINATION OF ANAEROBIC DIGESTATE AND BETAINE TO CREATE A HEAT-TREATED COMBINATION OF ANAEROBIC DIGESTATE AND BETAINE OPERATION 511, the combination of anaerobic digestate and betaine is maintained in the treatment vessel at or above 130 degrees F. for at least 24 hours to ensure uniform heat transfer to the combination of anaerobic digestate and betaine. In one embodiment, the combination of anaerobic digestate and betaine may be filtered as it is heated at HEAT THE COMBINATION OF ANAEROBIC DIGESTATE AND BETAINE TO CREATE A HEAT-TREATED COMBINATION OF ANAEROBIC DIGESTATE AND BETAINE OPERATION 511 as part of the treatment process. In one embodiment, the heat-treatment of HEAT THE COMBINATION OF ANAEROBIC DIGESTATE AND BETAINE TO CREATE A HEAT-TREATED COMBINATION OF ANAEROBIC DIGESTATE AND BETAINE OPERATION 511 may be performed for 120 hours or more, if desired.

In one embodiment, water may be blended with the combination of anaerobic digestate and betaine at HEAT THE COMBINATION OF ANAEROBIC DIGESTATE AND BETAINE TO CREATE A HEAT-TREATED COMBINATION OF ANAEROBIC DIGESTATE AND BETAINE OPERATION 511 to meet the desired nitrogen per weight or volume requirements of the combination of betaine and anaerobic digestate. In one embodiment, water may also be used to recover losses due to evaporation during the heat-treatment process of HEAT THE COMBINATION OF ANAEROBIC DIGESTATE AND BETAINE TO CREATE A HEAT-TREATED COMBINATION OF ANAEROBIC DIGESTATE AND BETAINE OPERATION 511. Water blending is typically not required, but is rather an optional procedure.

In one embodiment, if at least a portion of the combination of anaerobic digestate and betaine of COMBINE THE ANAEROBIC DIGESTATE AND THE BETAINE TO CREATE A COMBINATION OF ANAEROBIC DIGESTATE AND BETAINE OPERATION 507 is optionally treated in the treatment vessel of TRANSFER THE COMBINATION OF ANAEROBIC DIGESTATE AND BETAINE INTO A TREATMENT VESSEL OPERATION 509 at HEAT THE COMBINATION OF ANAEROBIC DIGESTATE AND BETAINE TO CREATE A HEAT-TREATED COMBINATION OF ANAEROBIC DIGESTATE AND BETAINE OPERATION 511 to create a heat-treated combination of anaerobic digestate and betaine, process flow proceeds to COOL THE HEAT-TREATED COMBINATION OF ANAEROBIC DIGESTATE AND BETAINE TO YIELD AN ANAEROBIC DIGESTATE BASED ORGANIC FERTILIZER PRODUCT OPERATION 513.

In one embodiment, at COOL THE HEAT-TREATED COMBINATION OF ANAEROBIC DIGESTATE AND BETAINE TO YIELD AN ANAEROBIC DIGESTATE BASED ORGANIC FERTILIZER PRODUCT OPERATION 513, the heat-treated combination of anaerobic digestate and betaine of HEAT THE COMBINATION OF ANAEROBIC DIGESTATE AND BETAINE TO CREATE A HEAT-TREATED COMBINATION OF ANAEROBIC DIGESTATE AND BETAINE OPERATION 511 is allowed to cool in the treatment vessel of TRANSFER THE COMBINATION OF ANAEROBIC DIGESTATE AND BETAINE INTO A TREATMENT VESSEL OPERATION 509.

As noted, in one embodiment, the cooling at COOL THE HEAT-TREATED COMBINATION OF ANAEROBIC DIGESTATE AND BETAINE TO YIELD AN ANAEROBIC DIGESTATE BASED ORGANIC FERTILIZER PRODUCT OPERATION 513 yields the resulting anaerobic digestate based organic fertilizer product.

In one embodiment, once the heat-treated combination of anaerobic digestate and betaine is cooled at COOL THE HEAT-TREATED COMBINATION OF ANAEROBIC DIGESTATE AND BETAINE TO YIELD AN ANAEROBIC DIGESTATE BASED ORGANIC FERTILIZER PRODUCT OPERATION 513 to yield the anaerobic digestate based organic fertilizer product, process flow proceeds to EXIT OPERATION 530 and the process for production of an anaerobic digestate based organic fertilizer product from anaerobic digestate and betaine 500 is exited.

Using the processes described above, an anaerobic digestate based organic fertilizer product is provided that is environmentally benign; is non-pathogenic; is derived from natural organic sources; does not require significant processing; has minimal odor; has a low viscosity liquid form; can be applied directly to agricultural vegetation; can be injected and/or added into irrigation streams; includes time-released nitrogen components which become bioavailable to agricultural vegetation by beneficial microbial digestion in soil; and eliminates chemical crop burning.

It should be noted that the language used in the specification has been primarily selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In the discussion above, certain aspects of one embodiment include process steps and/or operations described herein for illustrative purposes in a particular order and/or grouping. However, the particular order and/or grouping shown and discussed herein are illustrative only and not limiting. Those of skill in the art will recognize that other orders and/or grouping of the process steps and/or operations are possible and, in some embodiments, one or more of the process steps and/or operations discussed above can be combined and/or deleted. In addition, portions of one or more of the process steps and/or operations can be re-grouped as portions of one or more other of the process steps and/or operations discussed herein. Consequently, the particular order and/or grouping of the process steps and/or operations discussed herein do not limit the scope of the invention as claimed below.

In addition, the operations shown in the figures are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. An anaerobic digestate based organic fertilizer product comprising a combination of anaerobic digestate and one or more stabilized liquid fish products.

2. The anaerobic digestate based organic fertilizer product of claim 1, wherein the anaerobic digestate is a by-product of anaerobic digestion of waste products.

3. The anaerobic digestate based organic fertilizer product of claim 1, further comprising one or more additives.

4. The anaerobic digestate based organic fertilizer product of claim 3, wherein one of the one or more additives is concentrated separator by-product.

5. The anaerobic digestate based organic fertilizer product of claim 3, wherein one of the one or more additives is betaine.

6. The anaerobic digestate based organic fertilizer product of claim 1, wherein the anaerobic digestate based organic fertilizer product is 10% to 90% anaerobic digestate.

7. The anaerobic digestate based organic fertilizer product of claim 1, wherein the one or more stabilized liquid fish products includes one or more liquid fish products treated with sulfuric acid, citric acid, and/or phosphoric acid.

8. The anaerobic digestate based organic fertilizer product of claim 1, wherein the combination of the anaerobic digestate and the one or more stabilized liquid fish products includes a nitrogen content in a range of 1 to 10 percent.

9. The anaerobic digestate based organic fertilizer product of claim 1, wherein the combination of the anaerobic digestate and the one or more stabilized liquid fish products includes a phosphate content in a range of 0.5 to 2.5 percent.

10. The anaerobic digestate based organic fertilizer product of claim 1, wherein the combination of the anaerobic digestate and the one or more stabilized liquid fish products includes a potassium content in a range of 1 to 7 percent.

11. A process of manufacturing an anaerobic digestate based organic fertilizer product comprising:
obtaining a quantity of anaerobic digestate;
obtaining a quantity of one or more stabilized liquid fish products; and
combining at least part of the quantity of the anaerobic digestate and at least part of the quantity of the one or more stabilized liquid fish products to yield a combination of anaerobic digestate and one or more stabilized liquid fish products, the combination of the anaerobic digestate and the one or more stabilized liquid fish products comprising the anaerobic digestate based organic fertilizer product.

12. The process of manufacturing the anaerobic digestate based organic fertilizer product of claim 11, wherein the anaerobic digestate is a by-product of anaerobic digestion of waste products.

13. The process of manufacturing the anaerobic digestate based organic fertilizer product of claim 11, further comprising:
obtaining a quantity of one or more additives; and
combining at least part of the quantity of the anaerobic digestate, at least part of the quantity of the one or more stabilized liquid fish products, and at least part of the quantity of the one or more additives to yield a combination of anaerobic digestate, one or more stabilized liquid fish products, and one or more additives, the combination of the anaerobic digestate, the one or more stabilized liquid fish products, and the one or more additives comprising the anaerobic digestate based organic fertilizer product.

14. The process of manufacturing the anaerobic digestate based organic fertilizer product of claim 13, wherein one of the one or more additives is concentrated separator by-product.

15. The process of manufacturing the anaerobic digestate based organic fertilizer product of claim 13, wherein one of the one or more additives is betaine.

16. The process of manufacturing the anaerobic digestate based organic fertilizer product of claim 11, wherein the combination of the anaerobic digestate and the one or more stabilized liquid fish products is 10% to 90% anaerobic digestate.

17. The anaerobic digestate based organic fertilizer product of claim 11, wherein the one or more stabilized liquid fish products includes one or more liquid fish products treated with sulfuric acid, citric acid, and/or phosphoric acid.

18. The process of manufacturing the anaerobic digestate based organic fertilizer product of claim 11, further comprising:
filtering at least a part of the combination of the anaerobic digestate and the one or more stabilized liquid fish products using a filter having a standard wire mesh size number of 200.

19. The process of manufacturing the anaerobic digestate based organic fertilizer product of claim 11, further comprising:
filtering at least a part of the combination of the anaerobic digestate and the one or more stabilized liquid fish products using a filter having a standard wire mesh size number in a range of 50 to 200.

20. The process of manufacturing the anaerobic digestate based organic fertilizer product of claim 11, further comprising:
heat-treating the combination of the anaerobic digestate and the one or more stabilized liquid fish products to yield a heat-treated combination of the anaerobic digestate and the one or more stabilized liquid fish products; and
cooling the heat-treated combination of the anaerobic digestate and the one or more stabilized liquid fish products to yield the anaerobic digestate based organic fertilizer product.

21. The process of manufacturing the anaerobic digestate based organic fertilizer product of claim 20, wherein heat-treating the combination of the anaerobic digestate and the one or more stabilized liquid fish products to yield the heat-treated combination of the anaerobic digestate and the one or more stabilized liquid fish products comprises heating the combination of the anaerobic digestate and the one or more stabilized liquid fish products to 130 degrees F.

22. The process of manufacturing the anaerobic digestate based organic fertilizer product of claim 20, further comprising:
filtering at least a portion of the heat-treated combination of the anaerobic digestate and the one or more stabilized liquid fish products using a filter having a standard wire size number in a range of 50 to 200.

23. The process of manufacturing the anaerobic digestate based organic fertilizer product of claim 11, wherein the anaerobic digestate based organic fertilizer product includes a nitrogen content in a range of 1 to 10 percent.

24. The process of manufacturing the anaerobic digestate based organic fertilizer product of claim 11, wherein the anaerobic digestate based organic fertilizer product includes a phosphate content in a range of 0.5 to 2.5 percent.

25. The process of manufacturing the anaerobic digestate based organic fertilizer product of claim 11, wherein the anaerobic digestate based organic fertilizer product includes a potassium content in a range of 1 to 7 percent.

26. A process for fertilization comprising:
obtaining a quantity of anaerobic digestate based organic fertilizer product, wherein the anaerobic digestate based organic fertilizer product includes a combination of anaerobic digestate and one or more stabilized liquid fish products; and
applying the anaerobic digestate based organic fertilizer product to agricultural vegetation.

27. The process for fertilization of claim 26, wherein the anaerobic digestate is a by-product of anaerobic digestion of waste products.

28. The process for fertilization of claim 26, wherein the combination of the anaerobic digestate and the one or more stabilized liquid fish products further comprises one or more additives.

29. The process for fertilization of claim 28, wherein one of the one or more additives is concentrated separator by-product.

30. The process for fertilization of claim 28, wherein one of the one or more additives is betaine.

31. The process for fertilization of claim 26, wherein the anaerobic digestate based organic fertilizer product is 10% to 90% anaerobic digestate.

32. The process for fertilization of claim 26, wherein the one or more stabilized liquid fish products includes one or more liquid fish products treated with sulfuric acid, citric acid, and/or phosphoric acid.

33. The process for fertilization of claim 26, wherein the combination of the anaerobic digestate and the one or more stabilized liquid fish products includes a nitrogen content in a range of 1 to 10 percent.

34. The process for fertilization of claim 26, wherein the combination of the anaerobic digestate and the one or more stabilized liquid fish products includes a phosphate content in a range of 0.5 to 2.5 percent.

35. The process for fertilization of claim 26, wherein the combination of the anaerobic digestate and the one or more stabilized liquid fish products includes a potassium content in a range of 1 to 7 percent.

36. The process for fertilization of claim 26, wherein applying the anaerobic digestate based organic fertilizer product to the agricultural vegetation comprises applying the anaerobic digestate based organic fertilizer product at a rate of 5 to 4000 gallons per acre.

37. The process for fertilization of claim 26, wherein applying the anaerobic digestate based organic fertilizer product to the agricultural vegetation comprises applying/adding the anaerobic digestate based organic fertilizer product directly to the agricultural vegetation and/or fields and/or soil and/or substrate supporting the agricultural vegetation.

38. The process for fertilization of claim 26, wherein applying the anaerobic digestate based organic fertilizer product to the agricultural vegetation comprises applying/adding the anaerobic digestate based organic fertilizer product to an irrigation system servicing the agricultural vegetation.

39. The process for fertilization of claim 26, wherein applying the anaerobic digestate based organic fertilizer product to the agricultural vegetation comprises adding the anaerobic digestate based organic fertilizer product to a liquid base to obtain a desired concentration of anaerobic digestate based organic fertilizer product.

40. The process for fertilization of claim 39 wherein the desired concentration of anaerobic digestate based organic fertilizer product is 10% to 90%.
